(19) United States
(12) Patent Application Publication
(10) Pub. No.: US 2026/0016845 A1
(43) Pub. Date: Jan. 15, 2026

(54) Interframe Power Gating

(71) Applicant: Advanced Micro Devices, Inc., Santa Clara, CA (US)

(72) Inventor: Indrani Paul, Austin, TX (US)

(73) Assignee: Advanced Micro Devices, Inc., Santa Clara, CA (US)

(21) Appl. No.: 18/772,534

(22) Filed: Jul. 15, 2024

(51) Int. Cl. G05F 1/46

(52) U.S. Cl. CPC G05F 1/462; G05F 1/468

(57) ABSTRACT

Interframe power gating is described. In one or more implementations, a system includes a first processor, a second processor that maintains state information within volatile storage embedded in the second processor, and a power multiplexer that supplies a retention voltage to the volatile storage when the first processor causes the second processor to operate in a powered-off state. In one or more implementations, a processing device is configured to preserve state information maintained within embedded volatile storage of an infrastructure processing unit based on a retention voltage supplied to the volatile storage when the processing device operates in a powered-off state in-between periods of operating in a powered-on state.

### BACKGROUND

Various computing architectures include multiple processors for improved performance. A system on chip (SoC), for example, includes a central processing unit (CPU) that executes an application workload by offloading rendering functions to a graphics processing unit (GPU). The GPU generates graphical frames to free-up bandwidth on the CPU for performing other functions. Offloading graphics or other processing tasks to a GPU improves performance of the SoC due to parallelization of the workload execution. However, performance gains achieved by a multi-processor system cause other challenges, such as increases in power consumption and decreases in battery life when compared to single-processor architectures.

### BRIEF DESCRIPTION OF THE DRAWINGS

FIG. 1 is a block diagram of a non-limiting example system that is operable to implement interframe power gating.

FIG. 2 is a block diagram of a non-limiting example of power multiplexer that is operable to implement interframe power gating.

FIG. 3 is a timing diagram of voltage telemetry captured from a non-limiting example system that is operable to implement interframe power gating.

FIG. 4 depicts flow chart of a procedure executed by a non-limiting example system that is operable to implement interframe power gating.

FIG. 5 is a block diagram of a processing system configured to execute one or more applications, in accordance with one or more implementations.

FIG. 6 is a block diagram of an accelerator unit (AU) configured to workloads for applications running on a processing system, in accordance with one or more implementations.

### DETAILED DESCRIPTION

During execution of applications by multi-processor systems, there are instances where individual processors remain idle. For instance, a multi-processor system includes a Central Processing Unit (CPU) that delegates graphics processing tasks to a Graphics Processing Unit (GPU). The GPU is responsible for rendering graphical frames to meet a frame rate specified by the CPU. These frames are produced at consistent intervals (e.g., thirty frames per second) to meet the time constraints of the program running on the CPU. However, there are periods when the GPU is idle, such as in-between periods where the GPU is generating and outputting a frame. During these idle periods, the system expends unnecessary power to keep an inactive GPU in an operationally ready state.

To mitigate power consumption and potentially extend battery life, the GPU is deactivated and transitioned into a powered-off state during these idle periods. The system reactivates the GPU from time to time to support the workload of the CPU. For example, the GPU is brought back to a powered-on state with enough lead time to generate another frame to support the program running on the CPU. While this approach improves power consumption by deactivating an idle GPU, system performance is negatively impacted due to the latency incurred while waiting for the GPU to transition between powered-on and powered-off states. The efficiency of program execution by the system is contingent on an ability of the GPU to swiftly transition back to the powered-on state and resume operations without delay.

In conventional systems, the latency experienced while waiting for a GPU to transition between powered-on and powered-off states is largely influenced by the time the system takes to save and restore state information of the GPU. For instance, a GPU comprises multiple infrastructure processing units (IPUs) that include embedded microcontrollers and/or local memory, such as embedded random-access memory (RAM), which preserve state information used by the IPUs when the GPU is active and generating a frame. When the GPU transitions to a powered-off state, this state information is wiped from the volatile storage (e.g., microcontroller registers, memories, caches) embedded in the IPUs. Conventionally, the IPU state information is preserved in another system memory (e.g., DRAM located outside the GPU), which remains powered throughout the GPU powered-off state. The process of preserving the state information by writing to and reading from the external memory each time the GPU transitions between powered-on and powered-off states contributes to latency of the GPU.

While conventional techniques for automatically preserving and restoring GPU state information enable power conservation and seamless program executions, these conventional approaches cause a system to experience high entry and exit latencies associated with transitioning between GPU powered-on and powered-off states, thereby reducing GPU performance. The benefits to a system from deactivating the GPU to conserve power are diminished if the GPU reactivation process is too time-consuming.

The techniques described herein enable interframe power gating, which reduces entry and exit latencies associated with transitions between GPU powered-on and powered-off states, thereby improving GPU performance while also conserving power when the GPU is idle. In one or more implementations, the latency associated with entering and exiting the GPU powered-off state is sufficiently reduced to allow deactivation of the GPU during brief idle periods that occur in-between consecutive frames. The GPU preserves state information without accessing external memory to enable transitions into and out of a powered-off state without impacting a frame rate or other performance metric of the GPU.

An example system includes a GPU that is configured to generate graphical frames or perform other tasks in support of a program or application executing on a CPU. Throughout the program execution, GPU utilization is not constant. The GPU, for instance, generates and outputs graphical frames according to a frame rate (e.g., sixty frames per second). In-between these frame periods, the GPU is idle and not contributing to the workload processed by the CPU or other parts of the system. The GPU includes at least one IPU that has an embedded or local volatile storage. For example, the volatile storage of the GPU includes a portion of volatile memory integrated in at least one IPU. As another example, the volatile storage of the GPU includes at least one register of a microcontroller integrated in at least one IPU. In each example, the volatile storage of the IPU maintains state information used when the GPU is active (e.g., generating and outputting a frame).

To conserve power when the GPU is idle, the system causes the GPU to transition to a powered-off state. In contrast to conventional techniques that preserve GPU state information during a powered-off state using external memory (e.g., DRAM that is separate from the GPU), the state information is preserved throughout the GPU powered-off state based on a retention voltage supplied directly to the volatile storage of the IPU. Rather than completely disabling power supplied to the GPU when the GPU transitions to a powered-off state, the retention voltage is supplied to embedded storage elements of the GPU to preserve the IPU state information throughout each period of GPU idleness. The retention voltage is sufficient to preserve the state information maintained in the volatile storage of the GPU. Supplying the retention voltage during a GPU powered-off state conserves electrical energy when compared to power consumed by the GPU when active and operating in the powered-on state.

In one or more implementations, the system includes a power multiplexer configured to supply the retention voltage to the volatile storage embedded in the GPU during the powered-off state. When the GPU transitions back to a powered-on state, the power multiplexer refrains from outputting the retention voltage, which allows the embedded volatile storage to be powered normally from a system voltage supplied to the GPU. By avoiding latency penalties incurred by conventional systems that preserve state information using external system memory, the example system balances power consumption and/or preserves battery life, without sacrificing GPU performance.

Advantages of interframe power gating are especially apparent when a multi-processor system executes a CPU-centric workload, or application (e.g., a game) where a frame rate is capped, and GPU utilization is less than one hundred percent. The low latency achieved through interframe power gating enables the GPU to operate in a powered-off state more frequently than a conventional system, including in-between outputting individual frames. Far less power is consumed by the system to keep the volatile storage of the GPU in a retention mode than if the GPU is operating in the powered-on state. In addition, power savings are amplified by enabling the GPU to operate in a powered-off state more frequently (e.g., in-between frames), which improves power consumption, battery life, and/or parallel-processing efficiency.

In some aspects, the techniques described herein relate to a system including: a first processor, a second processor that maintains state information within volatile storage embedded in the second processor, and a power multiplexer that supplies a retention voltage to the volatile storage when the first processor causes the second processor to operate in a powered-off state.

In some aspects, the techniques described herein relate to a system, wherein the second processor is a graphics processing unit.

In some aspects, the techniques described herein relate to a system, wherein the first processor causes the graphics processing unit to operate in the powered-off state in-between rendering consecutive graphic frames.

In some aspects, the techniques described herein relate to a system, wherein the power multiplexer refrains from supplying the retention voltage to the volatile storage when the first processor causes the second processor to operate in a powered-on state.

In some aspects, the techniques described herein relate to a system, further including: a voltage regulator that supplies a normal voltage to the second processor when the second processor operates in a powered-on state and supplies the retention voltage through the power multiplexer and to the volatile storage when the second processor operates in the powered-off state.

In some aspects, the techniques described herein relate to a system, wherein the voltage regulator is a system voltage regulator that supplies the normal voltage to second processor through a digital low-dropout regulator when the second processor operates in the powered-on state.

In some aspects, the techniques described herein relate to a system, wherein the digital low-dropout regulator suppresses the normal voltage supplied to the second processor when the second processor operates in the powered-off state.

In some aspects, the techniques described herein relate to a system, wherein the power multiplexer supplies the retention voltage to the volatile storage when the digital low-dropout regulator suppresses the normal voltage supplied to the second processor.

In some aspects, the techniques described herein relate to a processing device including: a retention voltage interface that receives a retention voltage when the processing device operates in a powered-off state, a normal voltage interface that receives a normal voltage supplied from a voltage regulator when the processing device operates in a powered-on state, and an infrastructure processing unit that maintains state information within an embedded volatile storage based on the retention voltage when the processing device operates in the powered-off state and based on the normal voltage when the processing device operates in the powered-on state.

In some aspects, the techniques described herein relate to a processing device, wherein the embedded volatile storage preserves the state information based on the retention voltage when operating in the powered-off state in-between operating in consecutive periods of the powered-on state.

In some aspects, the techniques described herein relate to a processing device, wherein the processing device is a graphics processing unit that renders one of two consecutive graphic frames during each of the consecutive periods of the powered-on state.

In some aspects, the techniques described herein relate to a processing device, wherein the retention voltage interface receives the retention voltage from a power multiplexer when the processing device operates in the powered-off state.

In some aspects, the techniques described herein relate to a processing device, wherein the normal voltage interface receives the normal voltage from a voltage regulator when the processing device operates in the powered-on state.

In some aspects, the techniques described herein relate to a processing device, wherein the voltage regulator is a digital low-dropout regulator.

In some aspects, the techniques described herein relate to a processing device, wherein the embedded volatile storage includes a portion of volatile memory integrated in the infrastructure processing unit.

In some aspects, the techniques described herein relate to a processing device, wherein the embedded volatile storage includes at least one register of a microcontroller integrated in the infrastructure processing unit.

In some aspects, the techniques described herein relate to a method including: receiving, by a processing device, a normal voltage supplied from a voltage regulator when operating in a powered-on state, generating, by the processing device, state information maintained in volatile storage of the processing device when operating in the powered-on state, receiving, by the processing device, a retention voltage supplied from a power multiplexer when operating in a powered-off state, and when operating in the powered-off state in-between periods of operating in the powered-on state, preserving, by the processing device, the state information maintained in the volatile storage based on the retention voltage.

In some aspects, the techniques described herein relate to a method, wherein the processing device is a graphics processing unit, the method further including: rendering, by the processing device, one of two consecutive graphic frames during each of the periods of operating in the powered-on state.

In some aspects, the techniques described herein relate to a method, wherein the volatile storage includes at least one of: a portion of volatile memory integrated in an infrastructure processing unit of the processing device or at least one register of a microcontroller integrated in the infrastructure processing unit.

In some aspects, the techniques described herein relate to a method, further including: executing, by the processing device, firmware or software that controls the power multiplexer to supply the retention voltage when operating in the powered-off state and suppress the retention voltage when operating in the powered-on state.

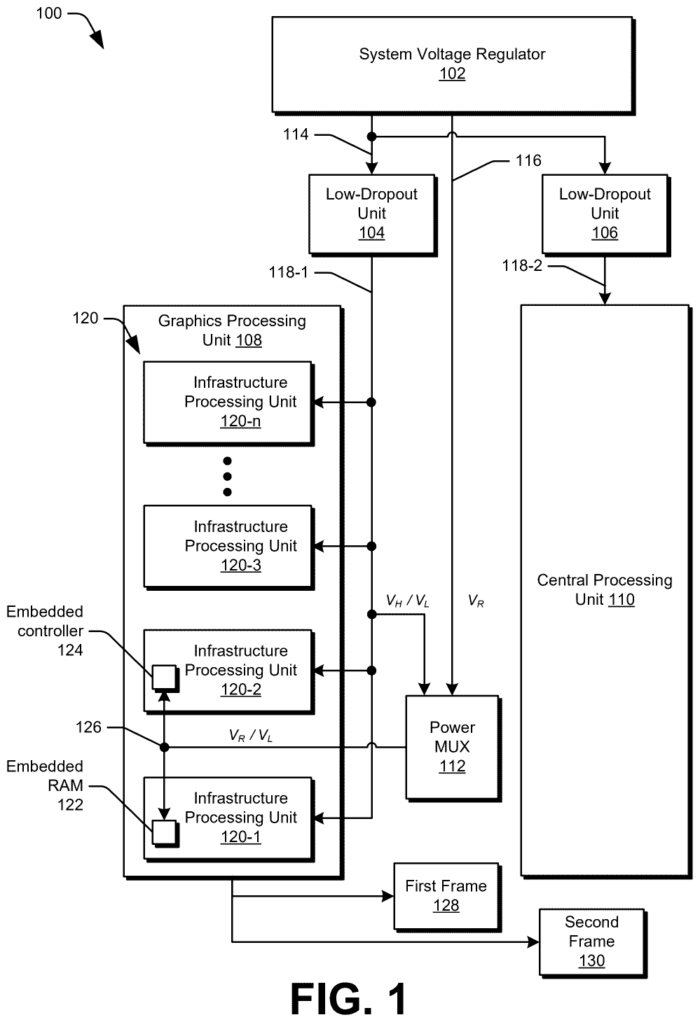

FIG. 1 is a block diagram of a non-limiting example system 100 that is operable to implement interframe power gating. The system 100 represents a multiple-processor system. In one or more implementation, the system 100 is a system on chip (SoC). The system 100 includes a system voltage regulator 102 that supplies electrical power through a low-dropout unit 104 and a low-dropout unit 106, respectively, to a graphics processing unit 108 and a central processing unit 110. The system 100 further includes a power multiplexer, labeled in FIG. 1 and referred to throughout this disclosure as a power MUX 112. Although not shown in the drawing of FIG. 1, the system 100 includes other components, such as a cache system, a memory hardware, or other storage system. Examples of devices in which the system 100 is implemented include, but are not limited to, supercomputers and/or computer clusters of high-performance computing (HPC) environments, data centers, servers, personal computers, laptops, desktops, game consoles, set top boxes, tablets, smartphones, mobile devices, virtual and/or augmented reality devices, wearables, medical devices, systems on chips, and other computing systems.

In accordance with the described techniques, components of the system 100 are coupled to one another via a wired or wireless connections, which are depicted in the illustrated example of FIG. 1 as unidirectional or bidirectional arrows. Example wired connections include, but are not limited to, buses, e.g., a data bus, interconnects, traces, and planes. A connection 114 electrically couples a normal voltage output from the system voltage regulator 102 to the low-dropout unit 104, as well as the low-dropout unit 106. A connection 116 electrically couples a retention voltage output from the system voltage regulator 102 to the power MUX 112. A connection 118-1 electrically couples a voltage output from the low-dropout unit 104 to the graphics processing unit 108 and the power MUX 112. A voltage output from the low-dropout unit 106 is electrically coupled to the central processing unit 110 via a connection 118-2.

The system 100 is a multi-processor system that has a plurality of processors. Although the system 100 is illustrated in FIG. 1 as including the graphics processing unit 108 and the central processing unit 110, in one or more variations, the system 100 includes at least one first processor that executes a workload (e.g., software, firmware) and at least one second processor that supports the workload execution of the first processor in-between periods of idleness. Additional examples of the processors of the system 100 therefore include, but are not limited to, an inference or artificial intelligence processing unit, a field programmable gate array (FPGA), an accelerated processing unit (APU), a digital signal processor (DSP), or other type of processor used in one or more of the types of systems described above.

The graphics processing unit 108 and the central processing unit 110 are each example electronic circuits that include one or more cores. The graphics processing unit 108 and the central processing unit 110 are operable to perform various operations of functions of the system 100 by executing instructions. For example, in one or more implementations, the central processing unit 110 reads program instruction (e.g., from memory, from cache, from storage) and executes the program instructions to perform various operations of an application, a service, a thread or other program hosted on the system 100. In at least one example, the system 100 loads firmware or software on the central processing unit 110, which when executed, configures the central processing unit 110 to offload various tasks to the graphics processing unit 108 performed in furtherance of a program execution. For example, the firmware or software executed by the central processing unit 110 configures the graphics processing unit 108 to generate and output graphical frames, which support execution of an application or program hosted on the central processing unit 110.

In one or more aspects, the low-dropout unit 104 and the low-dropout unit 106 are digital low-dropout regulators. As digital low-dropout regulators, the low-dropout unit 104 and the low-dropout unit 106 are separate circuits that perform power related functions (e.g., macros, droop detectors, header based regulation controlled powered gating). The circuits of the low-dropout unit 104 and the low-dropout unit 106 control when to turn off and when to turn on a normal voltage supplied from the system voltage regulator 102 to the connections 118-1 and 118-2, respectively. The low-dropout unit 104 controls electricity supplied to the graphics processing unit 108 and the power MUX 112 via the connection 118-1. The low-dropout unit 106 controls electricity supplied to the central processing unit 110 via the connection 118-2.

As depicted in FIG. 1, the graphics processing unit 108 includes a plurality of infrastructure processing units 120, which are labeled individually as infrastructure processing unit 120-1, infrastructure processing unit 120-2, and infrastructure processing unit 120-3 through infrastructure processing unit 120-n, where n is any integer. One example of the infrastructure processing units 120 is a stream engine responsible for executing shader programs including tasks related to pixel shading, vertex shading, and other compute workloads. Another example of the infrastructure processing units 120 is a graphics engine that handles rendering tasks, or a command processor that manages receipt and execution of commands received from the central processing unit 110. Display frame lock logic is another example of the infrastructure processing units 120, which ensures synchronization between the graphics processing unit 108 and display refresh rates to improve visual or graphics display quality.

At least one of the infrastructure processing units 120 of the graphics processing unit 108 includes volatile storage. Examples of the volatile storage of the infrastructure processing units 120 includes embedded registers (e.g., of embedded microcontrollers), embedded memory (e.g., RAM), or other embedded non-persistent storage where state information of the infrastructure processing unit is maintained to support operations of the graphics processing unit 108.

The infrastructure processing unit 120-1, for example, represents a system direct memory access engine that enables data transfers between a memory of the system 100 (e.g., DRAM) and the graphics processing unit 108 without involving the central processing unit 110, which improves overall performance of the system 100. The infrastructure processing unit 120-1 includes an embedded RAM 122 for improving efficiency of paging operations performed with the system memory.

As another example infrastructure processing unit with embedded volatile storage, the infrastructure processing unit 120-2 represents a command processor read level cache that includes an embedded controller 124. The embedded controller 124 (e.g., a microcontroller) uses the embedded volatile storage (e.g., one or more registers, one or more buffers) to maintain frequently accessed commands and improve command processing efficiency of the graphics processing unit 108.

In contrast to volatile storage in infrastructure processing units of a conventional system, the volatile storage embedded in one or more of the infrastructure processing units 120 of the system 100 is not wiped, erased, or cleared when the graphics processing unit 108 enters a powered-off state (e.g., where power supplied by the system voltage regulator 102 is suppressed from the connection 118-1). Instead, the system 100 implements interframe power gating techniques, which supply a retention voltage to the embedded volatile storage of the infrastructure processing units 120 when the graphics processing unit 108 transitions from a powered-on state to the powered-off state. The retention voltage supplied to the infrastructure processing units 120 configures the embedded volatile storage (e.g., the embedded RAM 122, the embedded controller 124) to operate in a retention mode for preserving the state information of the graphics processing unit 108 until the graphics processing unit 108 exits the powered-off state and transitions back to the powered-on state.

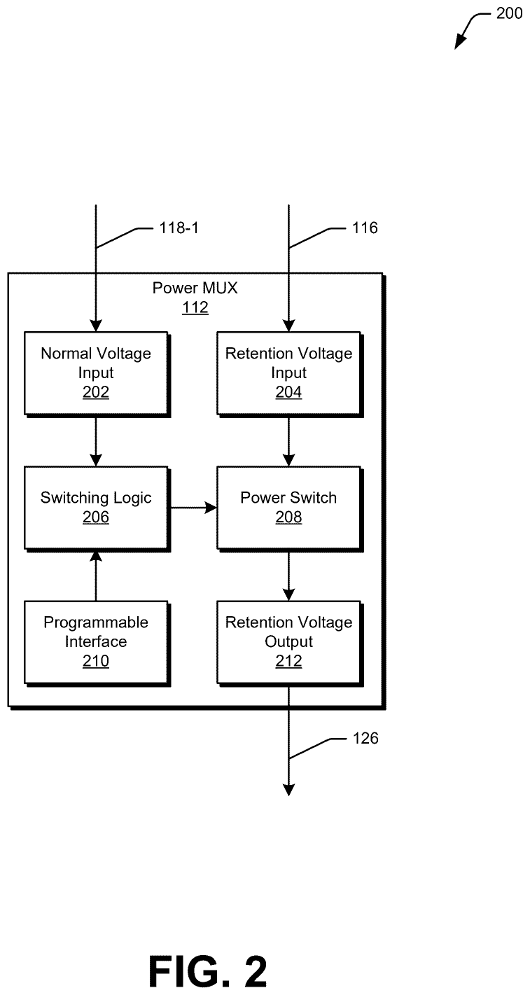

To implement interframe power gating, the power MUX 112 relays a retention voltage received from the connection 116 over a separate connection 126 that electrically couples the power MUX 112 to the graphics processing unit 108. The connection 126 is isolated from the connection 118-1 and directly couples the power MUX 112 to each volatile storage that is embedded the infrastructure processing units 120. The connection 126 is used by the power MUX 112 to supply the retention voltage obtained via the connection 116 to the embedded RAM 122, the embedded controller 124, or other embedded volatile storage of the graphics processing unit 108 to persistently store the state information when the low-dropout unit 104 suppresses the power supplied from the system voltage regulator 102 from the connection 118-1. The power MUX 112 represents an electrical circuit including hardware components that enable the electrically coupling of the connection 126 to the connection 116 or electrical isolation between the connection 126 and the connection 118-1. Further details of the power MUX 112 are depicted in an example embodiment shown in FIG. 2.

To aid in understanding of the interframe power gating techniques performed by the system 100, consider an example where an application is executing on the central processing unit 110 with support from the graphics processing unit 108 to execute rendering and graphic routines. For example, the central processing unit 110 commands the graphics processing unit 108 to output graphical frames that support the application execution. At a first time, the central processing unit 110 instructs the graphics processing unit 108 to operate in a powered-on state to output a first frame 128. In one or more implementations, the graphics processing unit 108 includes an interface to the low-dropout unit 104. The low-dropout unit 104 is controlled by firmware or software executing in the system 100 to supply the normal voltage to embedded volatile storage of the graphics processing unit 108 when the graphics processing unit 108 operates in the powered-on state. Then, at a second time (e.g., after the first time), and according to an application frame rate, the central processing unit 110 commands the graphics processing unit 108 to operate in the powered-on state and output a second frame 130. In at least one variation, the graphics processing unit 108 maintains state information within volatile storage associated with the embedded controller 124 and/or the embedded RAM 122 when generating and outputting each of the first frame 128 and the second frame 130.

In-between outputting the first frame 128 and the second frame 130, the graphics processing unit 108 is idle and not supporting the workload processed by the central processing unit 110. During these brief idle periods, the central processing unit 110 causes the graphics processing unit 108 to operate in a powered-off state. For example, firmware or software executing in the system 100 (e.g., on the central processing unit 110) causes the graphics processing unit 108 to transition from operating in the powered-on state to operating in a powered-off state. In one or more examples, the low-dropout unit 104 is further controlled to suppress the normal voltage from the embedded volatile storage of the graphics processing unit 108 when the graphics processing unit 108 operates in the powered-off state. In one or more implementations, the graphics processing unit 108 enters the powered-off state in response to the low-dropout unit 104 reducing the voltage supplied on the connection 118-1 from a normal voltage (e.g., a high voltage V_{H}) to a zero voltage (e.g., a low voltage V_{L}). Electrical energy saved from operating the graphics processing unit 108 in the powered-off state improves power consumption and/or extends battery life of the system 100, overall.

To improve entry latency and exit latency associated with transitioning the graphics processing unit 108 into and out of the powered-off state, the state information maintained within the volatile storage associated with the embedded controller 124 and/or the embedded RAM 122 is preserved without accessing (e.g., writing to or reading from) external memory of the graphics processing unit 108 (e.g., without accessing DRAM of the system 100). By refraining from accessing memory outside the graphics processing unit 108 to preserve the state information, the graphics processing unit 108 is operable to transition into and out of a powered-off state during brief idle periods, including idle periods that occur in-between outputting the first frame 128 and the second frame 130. To preserve the state information maintained in the graphics processing unit 108 during the power-off state, the power MUX 112 supplies a retention voltage (e.g., a non-zero voltage V_{R} that is less than the high voltage V_{H} and greater than the low voltage V_{L}) over the connection 126 to configure the embedded volatile storage of the graphics processing unit 108 as persistent storage operating in a retention mode. In at least one example, the graphics processing unit 108 shares an interface (e.g., the connection 126) to the power MUX 112, which is operable to supply the retention voltage to embedded volatile storage of the graphics processing unit 108 when the graphics processing unit 108 operates in the powered-off state.

For example, when the graphics processing unit 108 operates in a powered-on state, the power MUX 112 and the low-dropout unit 104 are controlled by the system 100 to cause the system voltage regulator 102 to supply a normal voltage V_{H} on the connection 118-1 with the graphics processing unit 108. Then, when the graphics processing unit 108 operates in a powered-off state, the system 100 controls the power MUX 112 to cause the retention voltage received from the connection 116 to be output on the connection 126 shared with the volatile storage of one or more of the infrastructure processing units 120. In one or more implementations, the power MUX 112 supplies the retention voltage on the connection 126 when the low-dropout unit 104 suppresses the normal voltage supplied to the graphics processing unit 108.

By avoiding latency penalties incurred by conventional systems that preserve state information using external system memory, the system 100 utilizes the power MUX 112 to balance power consumption and/or preserve battery life, without sacrificing performance of the graphics processing unit 108. The low latency achieved through interframe power gating enables the graphics processing unit 108 to operate in a powered-off state more frequently than a conventional system, including in-between outputting the first frame 128 and the second frame 130. Far less power is consumed by the system 100 to keep the volatile storage of the graphics processing unit 108 in a retention mode than if the graphics processing unit 108 is operating in the powered-on state. These power savings are increased further because the graphics processing unit 108 is allowed to operate in a powered-off state more frequently (e.g., in-between frames) than a conventional system, which further improves power consumption, battery life, and parallel-processing efficiency of the system 100.

FIG. 2 is a block diagram of a non-limiting example of power multiplexer 200 that is operable to implement interframe power gating. The power multiplexer 200 is a detailed example of the power MUX 112 depicted in FIG. 1.

In the example shown in FIG. 2, the power MUX 112 is an electrical circuit having hardware components, and optional software or firmware components that implement functionality of the power MUX 112 as described herein. The power MUX 112 includes a normal voltage input 202 coupled to the connection 118-1 and a retention voltage input 204 coupled to the connection 116. The power MUX 112 also includes switching logic 206 (e.g., an electrical circuit, a programmable logic block, a firmware routine) that is configured to control a switching state of a power switch 208. A programmable interface 210 is used by firmware or software executing within the system 100 (e.g., on the central processing unit 110) to configure the switching logic 206 for controlling, among other things, the power switch 208. A retention voltage output 212 of the power MUX 112 is coupled to the connection 126.

As discussed above in describing the system 100, the power MUX 112 outputs a retention voltage to the connection 126 when the central processing unit 110 causes the graphics processing unit 108 to operate in a powered-off state, such as, in-between rendering consecutive graphic frames (e.g., in-between outputting the first frame 128 and the second frame 130). The power MUX 112 refrains from supplying the retention voltage V_{R} to the volatile storage when the central processing unit 110 causes the graphics processing unit 108 to operate in a powered-on state.

In one or more examples, the switching logic 206 is configured via the programmable interface 210 to detect when the voltage level received at the normal voltage input 202 drops from the normal voltage (e.g., the high voltage V_{H}) to the zero voltage (e.g., the low voltage V_{L}). When the voltage supplied to the graphics processing unit 108 via the connection 118-1 is at the normal voltage level, the switching logic 206 maintains the power switch 208 in an open switching state to electrically isolate the retention voltage input 204 from to the retention voltage output 212. The retention voltage V_{R} output on the connection 116 is suppressed by the power MUX 112 from the connection 126 shared with the embedded RAM 122 and the embedded controller 124 is kept at the zero voltage level. Conversely, when the voltage supplied to the graphics processing unit 108 via the connection 118-1 is suppressed by the low-dropout unit 104, the switching logic 206 detects the zero voltage on the connection 118-1 and closes the power switch 208 to electrically couple the retention voltage input 204 to the retention voltage output 212. The retention voltage V_{R} output on the connection 116 is allowed to pass through the power MUX 112 and onto the connection 126 shared with the embedded RAM 122 and the embedded controller 124 of the infrastructure processing units 120-1 and 120-2, respectively.

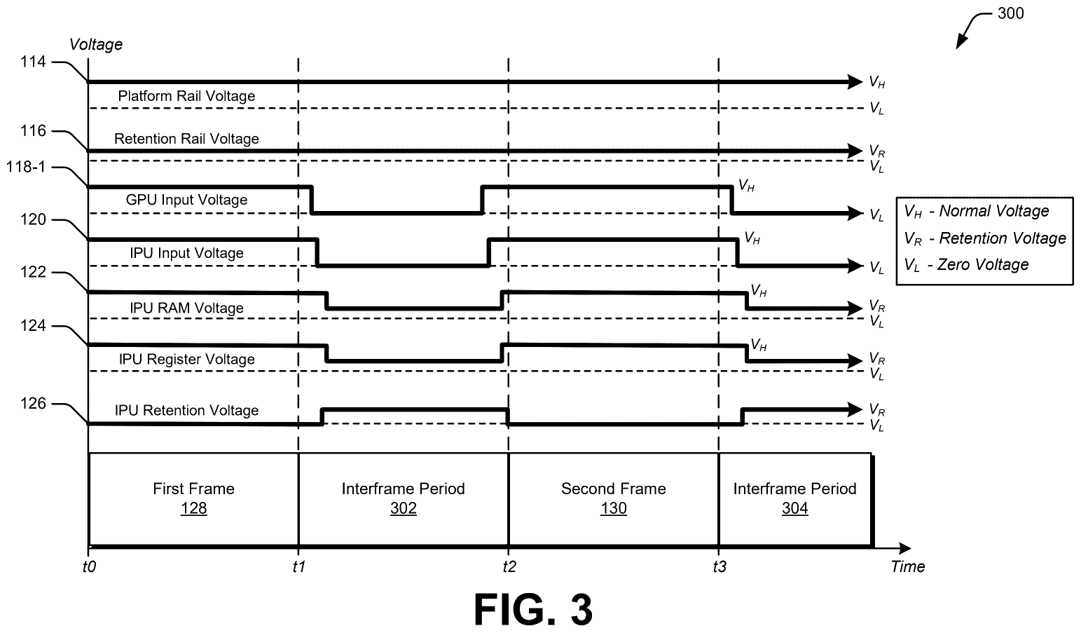

FIG. 3 is a timing diagram of voltage telemetry 300 captured from a non-limiting example system that is operable to implement interframe power gating. The timing diagram is described in the context of voltages measured overtime at different location in the system 100.

The graphics processing unit 108 is operating in the powered-on state to render two consecutive graphic frames during successive periods depicted by the voltage telemetry 300. The graphics processing unit 108 renders the first frame 128 between times t0 and t1. The graphics processing unit 108 renders the second frame 130 between times t2 and t3.

In-between the time periods during which the first frame 128 and the second frame 130 are rendered or output for display, the graphics processing unit 108 operates in a powered-off state. For example, an interframe period 302 occurs between times t1 and t2 and an interframe period 304 occurs after time t3. During the interframe period 302 and the interframe period 304, the system 100 causes the graphics processing unit 108 to function in the powered-off state to conserve power. The graphics processing unit 108 is idle and not drawing power from the connection 118-1 in-between outputting the first frame 128 and the second frame 130.

A platform rail voltage measured from the connection 114 is shown in FIG. 3 as remaining constant at the normal voltage V_{H} from time to and beyond. A retention rail voltage measured from the connection 116 is shown in FIG. 3 as also remaining constant at the retention voltage V_{R} from time to and beyond.

A GPU input voltage to the graphics processing unit 108 is measured at the connection 118-1. To maintain the graphics processing unit 108 in a powered-on state for generating and outputting the first frame 128 and the second frame 130, the voltage level of the connection 118-1 is kept at the normal voltage V_{H} between times t0 and t1 and between times t2 and t3. To operate the graphics processing unit 108 in a powered-off state (e.g., during the interframe period 302 and the interframe period 304), the voltage level of the connection 118-1 is kept at the zero voltage V_{L} between times t1 and t2 and beyond t3. An IPU input voltage to the infrastructure processing units 120 is shown to behave similarly to the GPU input voltage measured at the connection 118-1. When the graphics processing unit 108 is operating in the powered-on state, the voltage level measured at the infrastructure processing units 120 is kept at the normal voltage V_{H} between times t0 and t1 and between times t2 and t3. When the graphics processing unit 108 is operating in the powered-off state, the voltage level measured at the infrastructure processing units 120 is kept at the zero voltage V_{L} between times t1 and t2 and beyond t3. By suppressing the GPU input voltage and the IPU input voltage, the system 100 conserves electrical energy in-between outputting frames (e.g., during the interframe period 302 and the interframe period 304).

An IPU RAM voltage measured at the embedded RAM 122 of the infrastructure processing unit 120-1, and an IPU register voltage measured at the embedded controller 124 of the processing unit 120-2 are depicted in the voltage telemetry 300. During periods where the graphics processing unit 108 is operating in the powered-on state, the IPU RAM voltage and the IPU register voltage track the IPU input voltage measured at the infrastructure processing units 120. However, during periods where the graphics processing unit 108 is operating in the powered-off state, the IPU RAM voltage and the IPU register voltage deviate from the IPU input voltage measured at the infrastructure processing units 120. Instead of being kept at the zero voltage V_{L} during the interframe period 302 and the interframe period 304, the IPU RAM voltage and the IPU register voltage are kept at the retention voltage V_{R} to preserve the state information maintained within the graphics processing unit 108 while idle (e.g., operating in the powered-off state).

As depicted in the voltage telemetry 300, the power MUX 112 outputs the retention voltage V_{R} as measured at the connection 126 during the interframe period 302 and the interframe period 304. Outside the interframe period 302 and the interframe period 304, the power MUX 112 suppresses the retention voltage V_{R} from the connection 126 and allows the IPU RAM voltage and the IPU register voltage to reach the normal voltage V_{H} supplied from the connection 118-1.

By providing the retention voltage V_{R} to the embedded volatile storage of the graphics processing unit 108 when the graphics processing unit 108 is idle, the graphics processing unit 108 achieves a low entry and exit latency into and out of each of the interframe periods 302 and 304. Electrical energy is preserved by keeping the graphics processing unit 108 in a powered-off state for a majority of the interframe periods 302 and 304, while still achieving an application frame rate for outputting the first frame 128 and the second frame 130. In contrast, a conventional system maintains a graphics processing unit in a powered-on state during the interframe periods 302 and 304 because saving and restoring state information from system memory takes too long to satisfy an application frame rate.

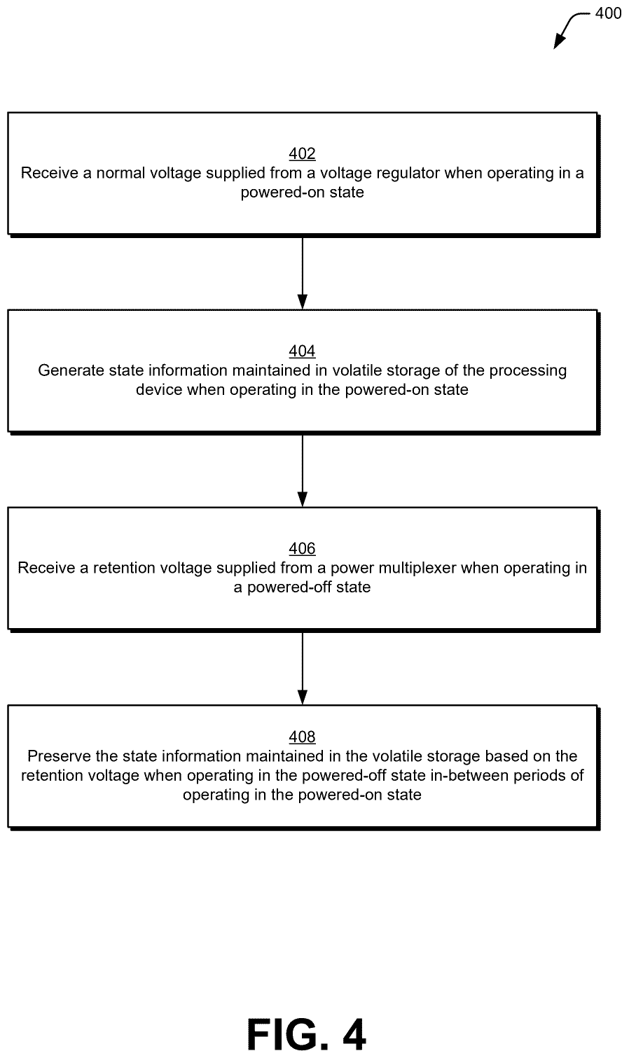

FIG. 4 depicts flow chart of a procedure 400 executed by a non-limiting example system that is operable to implement interframe power gating. The procedure 400 depicted in FIG. 4 is described as being performed by the graphics processing unit 108 of the system 100.

The procedure 400 begins and proceeds to block 402. The graphics processing unit 108 receives a normal voltage supplied from the system voltage regulator 102 and/or the low-dropout unit 104 when the graphics processing unit 108 is operating in a powered-on state. The graphics processing unit 108, in one or more aspects, renders one of two consecutive graphic frames 128 and 130 when the graphics processing unit 108 is operating in the powered-on state outside each of the interframe periods 302 and 304.

Next, at block 404, the graphics processing unit 108 generates state information maintained in volatile storage of the graphics processing unit 108 when the graphics processing unit is operating in the powered-on state. For example, the embedded RAM 122 maintains state information of the infrastructure processing unit 120-1 when the graphics processing unit 108 is generating the first frame 128 and/or the second frame 130. As another example, the embedded controller 124 maintains state information of the infrastructure processing unit 120-2 when the graphics processing unit 108 is generating the first frame 128 and/or the second frame 130.

After block 404 the procedure proceeds to block 406. The graphics processing unit 108 receives a retention voltage supplied from the power MUX 112 when the graphics processing unit 108 is operating in a powered-off state. As one example, the power MUX 112 causes the connection 126 to supply the retention voltage received from the system voltage regulator 102 via the connection 116. For example, the graphics processing unit 108, the central processing unit 110, or other hardware block of the system 100 executes firmware or software that communicates through the programmable interface 210 to the control logic 206 and configure the power MUX 112 to supply the retention voltage when the graphics processing unit 108 is operating in the powered-off state and suppress the retention voltage when the graphics processing unit 108 is operating in the powered-on state.

Lastly, at block 408, the graphics processing unit 108 preserves the state information maintained in the volatile storage based on the retention voltage when the graphics processing unit 108 is operating in the powered-off state in-between periods of operating in the powered-on state. For example, the state information maintained by the embedded RAM 122 and the embedded controller 124 is preserved based on the retention voltage when the graphics processing unit 108 is idle and operating in the powered-off state, in-between periods where the graphics processing unit 108 is outputting the first frame 128 and/or the second frame 130.

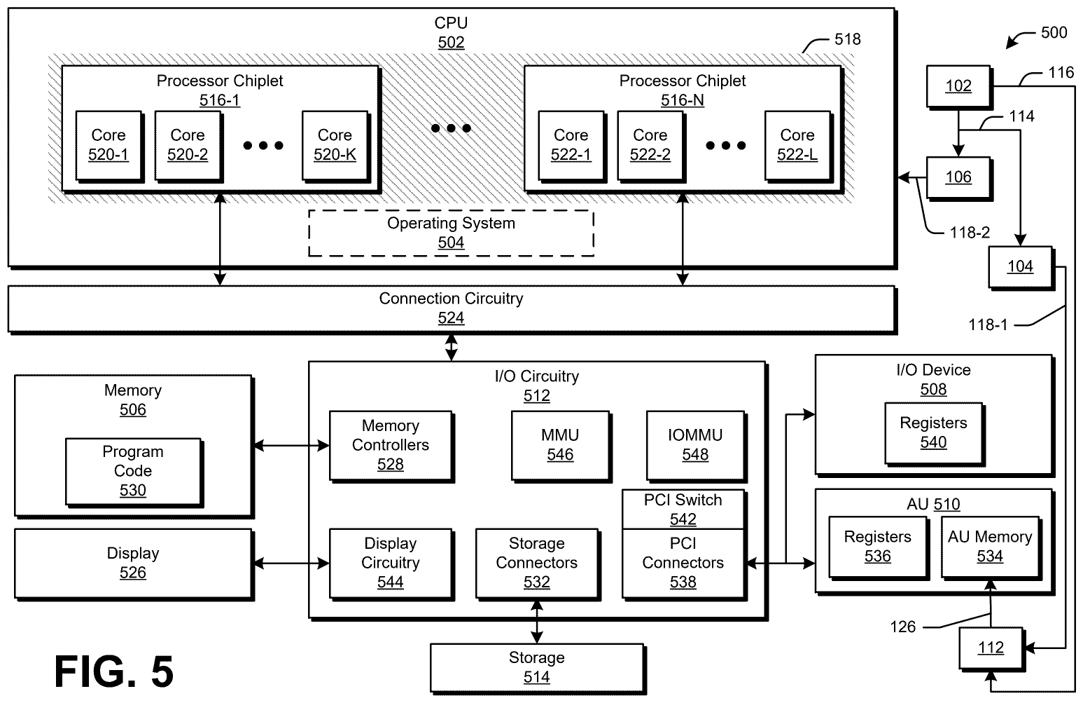

FIG. 5 includes a processing system 500 configured to execute one or more applications, such as compute applications (e.g., machine-learning applications, neural network applications, high-performance computing applications, databasing applications, gaming applications), graphics applications, and the like. Examples of devices in which the processing system is implemented include, but are not limited to, a server computer, a personal computer (e.g., a desktop or tower computer), a smartphone or other wireless phone, a tablet or phablet computer, a notebook computer, a laptop computer, a wearable device (e.g., a smartwatch, an augmented reality headset or device, a virtual reality headset or device), an entertainment device (e.g., a gaming console, a portable gaming device, a streaming media player, a digital video recorder, a music or other audio playback device, a television, a set-top box), an Internet of Things (IoT) device, an automotive computer or computer for another type of vehicle, a networking device, a medical device or system, and other computing devices or systems.

In the illustrated example, the processing system 500 includes a central processing unit (CPU) 502. In one or more implementations, the CPU 502 is configured to run an operating system (OS) 504 that manages the execution of applications. For example, the OS 504 is configured to schedule the execution of tasks (e.g., instructions) for applications, allocate portions of resources (e.g., system memory 506, CPU 502, input/output (I/O) device 508, accelerator unit (AU) 510, storage 514) for the execution of tasks for the applications, provide an interface to I/O devices (e.g., I/O device 508) for the applications, or any combination thereof.

In this example, the system voltage regulator 102, the low-dropout unit 104, the low-dropout unit 106, and the power MUX 112 are each depicted in the processing system 500. In variations, however, one or more of the system voltage regulator 102, the low-dropout unit 104, the low-dropout unit 106, and the power MUX 112 are included in and/or is implemented by one or more components of the processing system 500, such as the CPU 502, the memory 506, the I/O device 508, the AU 510, the I/O circuitry 512, the storage 514, and so forth. In at least one implementation, the system voltage regulator 102, the low-dropout unit 104, the low-dropout unit 106, and the power MUX 112 or portions of one or more of the system voltage regulator 102, the low-dropout unit 104, the low-dropout unit 106, and the power MUX 112 are included in at least two of the depicted components of the processing system 500. By way of example, one or more of the system voltage regulator 102, the low-dropout unit 104, the low-dropout unit 106, and the power MUX 112 may be included in or otherwise implemented by at least the CPU 502 and the AU 510.

The CPU 502 includes one or more processor chiplets 516, which are communicatively coupled together by a data fabric 518 in one or more implementations. Each of the processor chiplets 516, for example, includes one or more processor cores 520, 522 configured to concurrently execute one or more series of instructions, also referred to herein as “threads,” for an application. Further, the data fabric 518 communicatively couples each processor chiplet 516-N of the CPU 502 such that each processor core (e.g., processor cores 520) of a first processor chiplet (e.g., 516-1) is communicatively coupled to each processor core (e.g., processor cores 522) of one or more other processor chiplets 516. Though the example embodiment presented in FIG. 5 shows a first processor chiplet (516-1) having three processor cores (520-1, 520-2, 520-K) representing a K number of processor cores 522 and a second processor chiplet (516-N) having three processor cores (e.g., 522-1, 522-2, 522-L) representing an L number of processor cores 522, in other implementations (L being an integer number greater than or equal to one), each processor chiplet 516 may have any number of processor cores 520, 522. For example, each processor chiplet 516 can have the same number of processor cores 520, 522 as one or more other processor chiplets 516, a different number of processor cores 520, 522 as one or more other processor chiplets 516, or both.

Examples of connections which are usable to implement data fabric include but are not limited to, buses (e.g., a data bus, a system, an address bus), interconnects, memory channels, through silicon vias, traces, and planes. Other example connections include optical connections, fiber optic connections, and/or connections or links based on quantum entanglement.

Additionally, within the processing system 500, the CPU 502 is communicatively coupled to an I/O circuitry 512 by a connection circuitry 524. For example, each processor chiplet 516 of the CPU 502 is communicatively coupled to the I/O circuitry 512 by the connection circuitry 524. The connection circuitry 524 includes, for example, one or more data fabrics, buses, buffers, queues, and the like. The I/O circuitry 512 is configured to facilitate communications between two or more components of the processing system 500 such as between the CPU 502, system memory 506, display 526, universal serial bus (USB) devices, peripheral component interconnect (PCI) devices (e.g., I/O device 508, AU 510), storage 514, and the like.

As an example, system memory 506 includes any combination of one or more volatile memories and/or one or more non-volatile memories, examples of which include dynamic random-access memory (DRAM), static random-access memory (SRAM), non-volatile RAM, and the like. To manage access to the system memory 506 by CPU 502, the I/O device 508, the AU 510, and/or any other components, the I/O circuitry 512 includes one or more memory controllers 528. These memory controllers 528, for example, include circuitry configured to manage and fulfill memory access requests issued from the CPU 502, the I/O device 508, the AU 510, or any combination thereof. Examples of such requests include read requests, write requests, fetch requests, pre-fetch requests, or any combination thereof. That is to say, these memory controllers 528 are configured to manage access to the data stored at one or more memory addresses within the system memory 506, such as by CPU 502, the I/O device 508, and/or the AU 510.

When an application is to be executed by processing system 500, the OS 504 running on the CPU 502 is configured to load at least a portion of program code 530 (e.g., an executable file) associated with the application from, for example, a storage 514 into system memory 506. This storage 514, for example, includes a non-volatile storage such as a flash memory, solid-state memory, hard disk, optical disc, or the like configured to store program code 530 for one or more applications.

To facilitate communication between the storage 514 and other components of processing system 500, the I/O circuitry 512 includes one or more storage connectors 532 (e.g., universal serial bus (USB) connectors, serial AT attachment (SATA) connectors, PCI Express (PCIe) connectors) configured to communicatively couple storage 514 to the I/O circuitry 512 such that I/O circuitry 512 is capable of routing signals to and from the storage 514 to one or more other components of the processing system 500.

In association with executing an application, in one or more scenarios, the CPU 502 is configured to issue one or more instructions (e.g., threads) to be executed for an application to the AU 510. The AU 510 is configured to execute these instructions by operating as one or more vector processors, coprocessors, graphics processing units (GPUs), general-purpose GPUs (GPGPUs), non-scalar processors, highly parallel processors, artificial intelligence (AI) processors (also known as neural processing units, or NPUs), inference engines, machine-learning processors, other multithreaded processing units, scalar processors, serial processors, programmable logic devices (e.g., field-programmable logic devices (FPGAs)), or any combination thereof.

In at least one example, the AU 510 includes one or more compute units that concurrently execute one or more threads of an application and store data resulting from the execution of these threads in AU memory 534. This AU memory 534, for example, includes any combination of one or more volatile memories and/or non-volatile memories, examples of which include caches, video RAM (VRAM), or the like. In one or more implementations, these compute units are also configured to execute these threads based on the data stored in one or more physical registers 536 of the AU 510.

To facilitate communication between the AU 510 and one or more other components of processing system 500, the I/O circuitry 512 includes or is otherwise connected to one or more connectors, such as PCI connectors 538 (e.g., PCIe connectors) each including circuitry configured to communicatively couple the AU 510 to the I/O circuitry such that the I/O circuitry 512 is capable of routing signals to and from the AU 510 to one or more other components of the processing system 500. Further, the PCIe connectors 538 are configured to communicatively couple the I/O device 508 to the I/O circuitry 512 such that the I/O circuitry 512 is capable of routing signals to and from the I/O device 508 to one or more other components of the processing system 500.

By way of example and not limitation, the I/O device 508 includes one or more keyboards, pointing devices, game controllers (e.g., gamepads, joysticks), audio input devices (e.g., microphones), touch pads, printers, speakers, headphones, optical mark readers, hard disk drives, flash drives, solid-state drives, and the like. Additionally, the I/O device 508 is configured to execute one or more operations, tasks, instructions, or any combination thereof based on one or more physical registers 540 of the I/O device 508. In one or more implementations, such physical registers 540 are configured to maintain data (e.g., operands, instructions, values, variables) indicating one or more operations, tasks, or instructions to be performed by the I/O device 508.

To manage communication between components of the processing system 500 (e.g., AU 510, I/O device 508) that are connected to PCI connectors 538, and one or more other components of the processing system 500, the I/O circuitry 512 includes PCI switch 542. The PCI switch 542, for example, includes circuitry configured to route packets to and from the components of the processing system 500 connected to the PCI connectors 538 as well as to the other components of the processing system 500. As an example, based on address data indicated in a packet received from a first component (e.g., CPU 502), the PCI switch 542 routes the packet to a corresponding component (e.g., AU 510) connected to the PCI connectors 538.

Based on the processing system 500 executing a graphics application, for instance, the CPU 502, the AU 510, or both are configured to execute one or more instructions (e.g., draw calls) such that a scene including one or more graphics objects is rendered. After rendering such a scene, the processing system 500 stores the scene in the storage 514, displays the scene on the display 526, or both. The display 526, for example, includes a cathode-ray tube (CRT) display, liquid crystal display (LCD), light emitting diode (LED) display, organic light emitting diode (OLED) display, or any combination thereof. To enable the processing system 500 to display a scene on the display 526, the I/O circuitry 512 includes display circuitry 544. The display circuitry 544, for example, includes high-definition multimedia interface (HDMI) connectors, DisplayPort connectors, digital visual interface (DVI) connectors, USB connectors, and the like, each including circuitry configured to communicatively couple the display 526 to the I/O circuitry 512. Additionally or alternatively, the display circuitry 544 includes circuitry configured to manage the display of one or more scenes on the display 526 such as display controllers, buffers, memory, or any combination thereof.

Further, the CPU 502, the AU 510, or both are configured to concurrently run one or more virtual machines (VMs), which are each configured to execute one or more corresponding applications. To manage communications between such VMs and the underlying resources of the processing system 500, such as any one or more components of processing system 500, including the CPU 502, the I/O device 508, the AU 510, and the system memory 506, the I/O circuitry 512 includes memory management unit (MMU) 546 and input-output memory management unit (IOMMU) 548. The MMU 546 includes, for example, circuitry configured to manage memory requests, such as from the CPU 502 to the system memory 506. For example, the MMU 546 is configured to handle memory requests issued from the CPU 502 and associated with a VM running on the CPU 502. These memory requests, for example, request access to read, write, fetch, or pre-fetch data residing at one or more virtual addresses (e.g., guest virtual addresses) each indicating one or more portions (e.g., physical memory addresses) of the system memory 506. Based on receiving a memory request from the CPU 502, the MMU 546 is configured to translate the virtual address indicated in the memory request to a physical address in the system memory 506 and to fulfill the request. The IOMMU 548 includes, for example, circuitry configured to manage memory requests (memory-mapped I/O (MMIO) requests) from the CPU 502 to the I/O device 508, the AU 510, or both, and to manage memory requests (direct memory access (DMA) requests) from the I/O device 508 or the AU 510 to the system memory 506. For example, to access the registers 540 of the I/O device 508, the registers 536 of the AU 510, and/or the AU memory 534, the CPU 502 issues one or more MMIO requests. Such MMIO requests each request access to read, write, fetch, or pre-fetch data residing at one or more virtual addresses (e.g., guest virtual addresses) which each represent at least a portion of the registers 540 of the I/O device 508, the registers 536 of the AU 510, or the AU memory 534, respectively. As another example, to access the system memory 506 without using the CPU 502, the I/O device 508, the AU 510, or both are configured to issue one or more DMA requests. Such DMA requests each request access to read, write, fetch, or pre-fetch data residing at one or more virtual addresses (e.g., device virtual addresses) which each represent at least a portion of the system memory 506. Based on receiving an MMIO request or DMA request, the IOMMU 548 is configured to translate the virtual address indicated in the MMIO or DMA request to a physical address and fulfill the request.

In variations, the processing system 500 can include any combination of the components depicted and described. For example, in at least one variation, the processing system 500 does not include one or more of the components depicted and described in relation to FIG. 5. Additionally or alternatively, in at least one variation, the processing system 500 includes additional and/or different components from those depicted. The 500 is configurable in a variety of ways with different combinations of components in accordance with the described techniques.

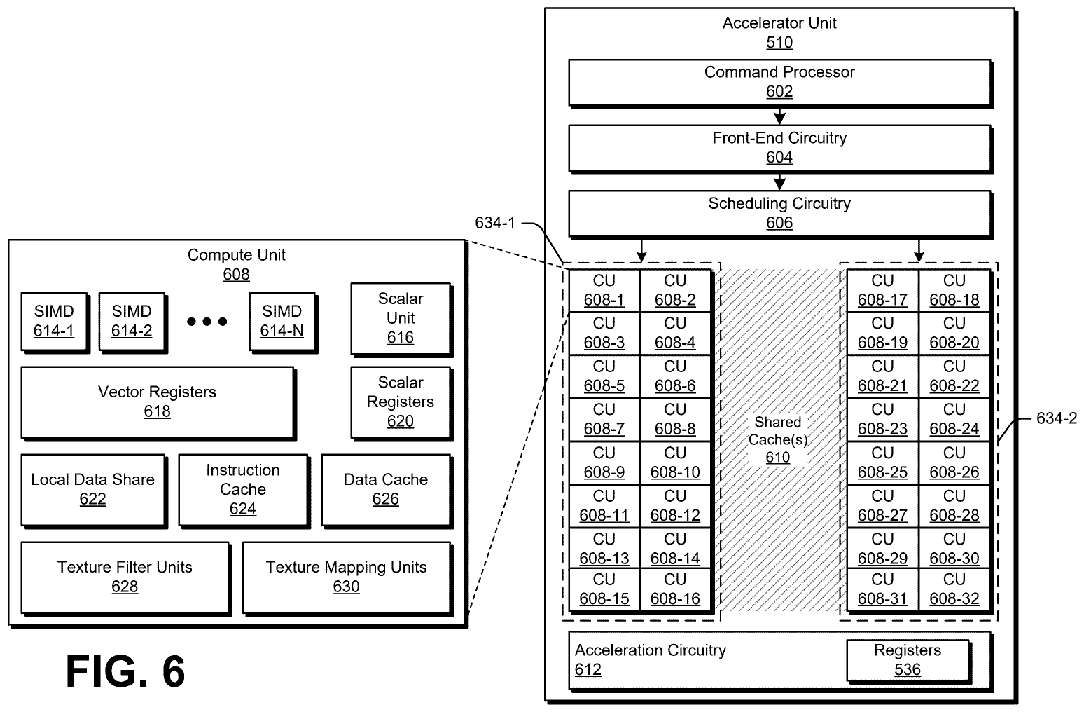

FIG. 6 depicts the AU 510, which is configured to execute workloads for one or more applications running on a processing system, such as the processing system 600. These applications include, for example, compute applications and/or graphics applications, each configured to issue respective series of instructions, also referred to herein as “threads,” to a central processing unit (e.g., the CPU 602) of the processing system. Compute applications, when executed by a processing system, cause the processing system to perform one or more computations, such as machine-learning, neural network, high-performance computing, or databasing computations.

Further, graphics applications, when executed by a processing system, cause the processing system to render a scene including one or more graphics objects and, as an example, output the scene on a display, such as the display 526. The instructions issued to the CPU from these applications, for example, include groups of threads, also referred to herein as “workgroups,” to be executed by AU 510. To perform these workgroups, the AU 510 includes one or more vector processors, coprocessors, graphics processing units (GPUs), general-purpose GPUs, non-scalar processors, highly parallel processors, artificial intelligence (AI) processors, inference engines, machine-learning processors, or any combination thereof. As an example, the AU 510 includes one or more command processors 602, front-end circuitry 604, scheduling circuitry 606, compute units 608, shared cache(s) 610, and acceleration circuitry 612.

A command processor 602 of AU 510 is configured to receive, from the CPU, a command stream indicating one or more workgroups to be executed. As an example, based on a compute application running on the processing system, the command processor 602 receives a command stream indicating workgroups that require compute operations such as matrix multiplication, addition, subtraction, and the like to be performed. As another example, based on a graphics application running on the processing system, the command processor 602 receives a command stream indicating workgroups that include draw calls for a scene to be rendered. After receiving a command stream, the command processor 602 parses the command stream and issues respective instructions of the indicated workgroups to the front-end circuitry 604, the scheduling circuitry 606, or both. As an example, based on a command stream from a graphics application, the command processor 602 issues one or more draw calls to the front-end circuitry 604. In one or more implementations, the front-end circuitry 604 includes one or more vertex shaders, polygon list builders, and so on.

Based on the instructions issued from the command processor 602, for instance, the front-end circuitry 604 is configured to position geometry objects in a scene, assemble primitives in a scene, cull primitives, perform visibility passes for primitives in a scene, generate visible primitive lists for a scene, or any combination thereof. In one example, based on a set of draw calls received from a command processor 602, the front-end circuitry 604 determines a list of primitives to be rendered for a scene. After determining a list of primitives to be rendered for the scene, the front-end circuitry 604 issues one or more draw calls (e.g., a workgroup) associated with the primitives in the list of primitives to the scheduling circuitry 606.

Based on the instructions of the workgroups received from a command processor 602, the front-end circuitry 604, or both, the scheduling circuitry 606 is configured to provide data indicating threads (e.g., operations for these threads) to be executed for these workgroups to one or more compute units 608.

In at least one implementation, each compute unit 608 is configured to support the concurrent execution of two or more threads of a workgroup. For example, each compute unit 608 is configured to concurrently execute a predetermined number of threads referred to herein as a “wavefront.” Based on the size of the wavefront of a compute unit 608, the scheduling circuitry 606 is configured to schedule one or more groups of threads of the workgroup, also referred to herein as “waves,” for execution by the compute unit 608.

As an example, the scheduling circuitry 606 first updates one or more registers of a compute unit 608 such that the compute unit 608 is configured to execute a first group of waves of the workgroup. After the compute unit 608 has executed the first group of waves, the scheduling circuitry 606 updates one or more registers of the compute unit 608 to schedule a second group of waves of the workgroup to be executed by the compute unit 608. To execute these waves, each compute unit is connected to one or more shared cache(s) 610. In one or more implementations, each of the shared cache(s) 610 includes a volatile memory, non-volatile memory, or both accessible by one or more of the compute units 608. These shared cache(s) 610, for example, are configured to store data (e.g., register files, values, operands, instructions, variables) used in the execution of one or more waves, data resulting from the performance of one or more waves, or both. Because a shared cache 610 is accessible by two or more compute units 608, a first compute unit 608 is capable of providing results from the execution of a first wave to a second compute unit 608 executing a second wave. Though the example presented in FIG. 6 shows AU 510 as including 32 compute units (608-1 to 608-32), in other implementations, the AU 510 can include any number of compute units 608, i.e., one or multiple compute units 608.

In the illustrated example, each compute unit 608 includes one or more single instruction, multiple data (SIMD) units 614, a scalar unit 616, one or more vector registers 618, one or more scalar registers 620, local data share 622, instruction cache 624, data cache 626, texture filter units 628, texture mapping units 630, or any combination thereof. In implementations, the compute unit 608 may be configured with different components than in the illustrated example. Additionally, in at least one variation, the AU 510 includes at least two different types of compute unit 608, such as a bank of a first compute unit type and a bank of a second compute unit type.

In one or more implementations, a SIMD unit 614 (e.g., a vector processor) is configured to concurrently perform multiple instances of the same operation for a wave. For example, a SIMD unit 614 includes two or more lanes each including an arithmetic logic unit (ALU) and each configured to perform the same operation(s) for the threads of a wave. Though the example embodiment presented in FIG. 6 shows a compute unit 608 including three SIMD units (614-1, 614-2, 614-N) representing an N number of SIMD units, in other implementations, a compute unit 608 can include any number of SIMD units 614, e.g., one or more SIMD units 614. Further, as an example, the size of a wavefront supported by the AU 510 is based on the number of SIMD units 614 included in each compute unit 608.

To determine the operations performed by the SIMD units 614, each compute unit 608 includes vector registers 618. In one or more implementations, the vector registers 618 are formed from one or more physical registers of the AU 510. These vector registers 618 are configured to store data (e.g., operands, values) used by the respective lanes of the SIMD units 614 to perform a corresponding operation for the wave. Additionally, each compute unit 608 includes a scalar unit 616 configured to perform scalar operations for the wave. As an example, the scalar unit 616 includes an ALU configured to perform scalar operations. To support the scalar unit 616, each compute unit 608 also includes scalar registers 620. In one or more implementations, the scalar registers are formed from one or more physical registers of the AU 510. These scalar registers 620 store data (e.g., operands, values) used by the scalar unit 616 to perform a corresponding scalar operation for the wave.

Further, each compute unit 608 includes a local data share 622. In one or more implementations, the local data share 622 is formed from a volatile memory (e.g., random-access memory) accessible by each SIMD unit 614 and the scalar unit 616 of the compute unit 608. That is to say, the local data share 622 is shared across each wave concurrently executing on the compute unit 608. The local data share 622 is configured to store data resulting from the execution of one or more operations for one or more waves, data (e.g., register files, values, operands, instructions, variables) used in the execution of one or operations for one or more waves, or both. As an example, the local data share 622 is used as a scratch memory to store results necessary for, aiding in, or helpful for the performance of one or more operations by one or more SIMD units 614.

The instruction cache 624 of a compute unit 608, for example, includes a volatile memory, non-volatile memory, or both configured to store the instructions to be executed for one or more waves executed by the compute unit 608. Further, the data cache 626 of a compute unit 608 includes a volatile memory, non-volatile memory, or both configured to store data (e.g., register files, values, operands, variables) used in the execution of one or more waves by the compute unit 608.

In at least one implementation, the instruction cache 624, the data cache 626, the shared cache(s) 610, and a system memory, for example, are arranged in a hierarchy based on the respective sizes of the caches. As an example, based on such a cache hierarchy, a compute unit 608 first requests data from a controller of a corresponding data cache 626. Based on the data not being in the data cache 626, the data cache 626 requests the data from a shared cache 610 at the next level of the cache hierarchy. The caches then continue in this way until the data is found in a cache or requested from the system memory, at which point, the data is returned to the compute unit 608.

Additionally, each compute unit 608 includes one or more texture mapping units 630 each including circuitry configured to map textures to one or more graphics objects (e.g., groups of primitives) generated by the compute units 608. Further, each compute unit 608 includes one or more texture filter units 628 each having circuitry configured to filter the textures applied to the generated graphics objects. For example, the texture filter units 628 are configured to perform one or more magnification operations, anti-aliasing operations, or both to filter a texture.

Additionally, to help perform instructions for one or more workgroups, AU 510 includes acceleration circuitry 612. Such acceleration circuitry 612 includes hardware (e.g., fixed-function hardware) configured to execute one or more instructions for one or more workgroups. As an example, the acceleration circuitry 612 includes one or more instances of fixed function hardware configured to encode frames, encode audio, decode frames, decode audio, display frames, output audio, perform matrix multiplication, or any combination thereof. To schedule instructions for execution on such hardware, the scheduling circuitry 606 is configured to update one or more physical registers 636 of the AU 510 associated with the hardware.

In some cases, the AU 510 includes one or more compute units 608 grouped into one or more shader engines 634 or engines for other types of computations, such as training and/or inference utilized to implement artificial intelligence. Referring to the embodiment depicted in FIG. 6, for example, the AU 510 includes compute units 608-1 to 608-16 grouped in a first shader engine 634-1 (or other type of engine) and compute units 608-17 to 608-32 grouped in a second shader engine 634-2 (or other type of engine). Such shader engines 634, for example, are configured to execute one or more workgroups (e.g., one or more compute kernels) for an application and include one or more compute units 608, graphics processing hardware (e.g., primitive assemblers, rasterizers), one or more shared cache(s) 610, render backends, or any combination thereof. Though the embodiment presented in FIG. 6 shows AU 510 as including two shader engines (634-1, 634-2), in other implementations, the AU 510 can include any number of shader engines (634-1, 634-2) or groupings for other types of operations.

It should be understood that many variations are possible based on the disclosure herein. Although features and elements are described above in particular combinations, each feature or element is usable alone without the other features and elements or in various combinations with or without other features and elements.

The various functional units illustrated in the figures and/or described herein (including, where appropriate, the system voltage regulator 102, the low-dropout unit 104, the low-dropout unit 106, the graphics processing unit 108, the central processing unit 110, the power MUX 112, the infrastructure processing units 120, the power multiplexer 200, the switching logic 206, and the programmable interface 210) are implemented in any of a variety of different manners such as hardware circuitry, software or firmware executing on a programmable processor, or any combination of two or more of hardware, software, and firmware. The methods provided are implemented in any of a variety of devices, such as a general-purpose computer, a processor, or a processor core. Suitable processors include, by way of example, a general purpose processor, a special purpose processor, a conventional processor, a digital signal processor (DSP), a graphics processing unit (GPU), a parallel accelerated processor, a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine.

In one or more implementations, the methods and procedures provided herein are implemented in a computer program, software, or firmware incorporated in a non-transitory computer-readable storage medium for execution by a general-purpose computer or a processor. Examples of non-transitory computer-readable storage mediums include a read only memory (ROM), a RAM, a register, cache memory, semiconductor memory devices, magnetic media such as internal hard disks and removable disks, magneto-optical media, and optical media such as CD-ROM disks, and digital versatile disks (DVDs).

What is claimed is:

1. A system comprising:
a first processor;
a second processor that maintains state information within volatile storage embedded in the second processor; and
a power multiplexer that supplies a retention voltage to the volatile storage when the first processor causes the second processor to operate in a powered-off state.

2. The system of claim 1, wherein the second processor is a graphics processing unit.

3. The system of claim 2, wherein the first processor causes the graphics processing unit to operate in the powered-off state in-between rendering consecutive graphic frames.

4. The system of claim 1, wherein the power multiplexer refrains from supplying the retention voltage to the volatile storage when the first processor causes the second processor to operate in a powered-on state.

5. The system of claim 1, further comprising:
a voltage regulator that supplies a normal voltage to the second processor when the second processor operates in a powered-on state and supplies the retention voltage through the power multiplexer and to the volatile storage when the second processor operates in the powered-off state.

6. The system of claim 5, wherein the voltage regulator is a system voltage regulator that supplies the normal voltage to second processor through a digital low-dropout regulator when the second processor operates in the powered-on state.

7. The system of claim 6, wherein the digital low-dropout regulator suppresses the normal voltage supplied to the second processor when the second processor operates in the powered-off state.

8. The system of claim 7, wherein the power multiplexer supplies the retention voltage to the volatile storage when the digital low-dropout regulator suppresses the normal voltage supplied to the second processor.

9. A processing device comprising:
a retention voltage interface that receives a retention voltage when the processing device operates in a powered-off state;
a normal voltage interface that receives a normal voltage supplied from a voltage regulator when the processing device operates in a powered-on state; and
an infrastructure processing unit that maintains state information within an embedded volatile storage based on the retention voltage when the processing device operates in the powered-off state and based on the normal voltage when the processing device operates in the powered-on state.

10. The processing device of claim 9, wherein the embedded volatile storage preserves the state information based on the retention voltage when operating in the powered-off state in-between operating in consecutive periods of the powered-on state.

11. The processing device of claim 10, wherein the processing device is a graphics processing unit that renders one of two consecutive graphic frames during each of the consecutive periods of the powered-on state.

12. The processing device of claim 9, wherein the retention voltage interface receives the retention voltage from a power multiplexer when the processing device operates in the powered-off state.

13. The processing device of claim 9, wherein the normal voltage interface receives the normal voltage from a voltage regulator when the processing device operates in the powered-on state.

14. The processing device of claim 9, wherein the voltage regulator is a digital low-dropout regulator.

15. The processing device of claim 9, wherein the embedded volatile storage includes a portion of volatile memory integrated in the infrastructure processing unit.

16. The processing device of claim 9, wherein the embedded volatile storage includes at least one register of a microcontroller integrated in the infrastructure processing unit.

17. A method comprising:
receiving, by a processing device, a normal voltage supplied from a voltage regulator when operating in a powered-on state;
generating, by the processing device, state information maintained in volatile storage of the processing device when operating in the powered-on state;
receiving, by the processing device, a retention voltage supplied from a power multiplexer when operating in a powered-off state; and
when operating in the powered-off state in-between periods of operating in the powered-on state, preserving, by the processing device, the state information maintained in the volatile storage based on the retention voltage.

18. The method of claim 17, wherein the processing device is a graphics processing unit, the method further comprising:
rendering, by the processing device, one of two consecutive graphic frames during each of the periods of operating in the powered-on state.

19. The method of claim 17, wherein the volatile storage includes at least one of:
a portion of volatile memory integrated in an infrastructure processing unit of the processing device or at least one register of a microcontroller integrated in the infrastructure processing unit.

20. The method of claim 17, further comprising:
executing, by the processing device, firmware or software that controls the power multiplexer to supply the retention voltage when operating in the powered-off state and suppress the retention voltage when operating in the powered-on state.
